(19) United States
(12) Patent Application Publication
(10) Pub. No.: US 2003/0121912 A1
(43) Pub. Date: Jul. 3, 2003

(54) Device and method for storing and managing recipe data for microwave oven

(76) Inventors: Choi Kyung-Hwan, Changwon Gyeongnam (KR); Park Won-Kyung, Masan Gyeongnam (KR)

Correspondence Address: FLESHNER & KIM, LLP, P.O. BOX 221200, CHANTILLY, VA, 20153, US

(21) Appl. No.: 10/146,947

(22) Filed: May 17, 2002

(30) Foreign Application Priority Data
Dec. 28, 2001 (KR) 2001-87319
Jan. 28, 2002 (KR) 2002-4909

(51) Int. Cl. H05B 6/66

(52) U.S. Cl. 219/702; 700/211

(57) ABSTRACT

The present invention relates to a device and method for storing and managing recipe data for a microwave oven, and more particularly, to a device and method for storing and managing recipe data for a microwave oven, wherein the recipe data for the microwave oven can be stored in the microwave oven and edited in a computer by connecting the microwave oven with the web-connected computer. According to the present invention, the microwave oven and the computer are connected to each other so that the recipe data downloaded from a web site can be stored in a memory device contained within a control block. The recipe data stored in the microwave oven can be confirmed on a screen of the computer. Furthermore, the recipe data stored in the microwave oven and other recipe data downloadable from the web site can be displayed together.

Thus, a user can store and use the recipe data the user wants among the recipe data provided from the web site so that various cooking can be performed. Further, the recipe data stored in the recipe storage unit of the microwave oven can be grasped at a glance, and at the same time, other downloadable recipe data can be confirmed.

### BACKGROUND OF THE INVENTION

1. Field of the Invention

The present invention relates to a device and method for storing and managing recipe data for a microwave oven, and more particularly, to a device and method for storing and managing recipe data for a microwave oven, wherein the recipe data for the microwave oven provided on a web site can be downloaded to the microwave oven by connecting the microwave oven with a web-connected computer.

2. Description of the Prior Art

Hereinafter, a control section of a conventional microwave oven will be explained as follows:

FIG. 1 is a block diagram of a control section of the conventional microwave oven.

As shown in the figure, the control section of the conventional microwave oven comprises a microcomputer 1′ in which programs to be performed according to respective functions of the microwave oven for performing a variety of control and operation are stored; a power circuit 2′ for receiving power supplied from the exterior, converting the power into power suitable for the microcomputer and supplying the converted power to the microcomputer 1′; an oscillation circuit 3′ for supplying reference clock pulses so that the microcomputer 1′ can perform the programs; a key input circuit 7′ for allowing a user to directly input the function of the microwave oven the user wants; and a touch panel 6′ for allowing the user to input the function of the microwave the user wants oven with the user's fingers, a pen, or the like.

The control section of the conventional microwave oven further comprises a display unit 5′ for notifying the user to confirm contents inputted from the key input, circuit 7′ or the touch panel 6′ and an operation state of the microwave oven; a relay control unit 4′ for controlling driving of a magnetron, a heater, a fan motor, an oven lamp, or the like so that the microwave oven can be operated in response to the contents inputted from the key input circuit 7′ or the touch panel 6′; and a recipe storage unit 8′ in which recipe data is stored.

Operation control procedures constructed as above will be explained as follows:

The user inputs a cooking function the user wants, through the key input circuit 7′ or the touch panel 6′. A control signal inputted through the key input circuit 7′ or the touch panel 6′ is transmitted to the microcomputer 1′. The microcomputer 1′ discriminates the signal and outputs a control signal to the relay control unit 4′. The relay control unit 4′ turns on a relay (not shown) connected to the magnetron, the heater, the fan motor, the oven lamp, or the like in response to the control signal of the microcomputer 1′.

Furthermore, the microcomputer 1′ reads the recipe data stored in the recipe storage unit 8′ and outputs a signal corresponding to the recipe data for the cooking function, which the user has selected, to the display unit 5′. Then, the display unit 5′ receives a control signal from the microcomputer 1′ to display the cooking data for the recipe function the user has selected.

According to the conventional microwave oven, when the recipe data stored in the recipe storage unit 8′ is to be edited, for example, deleted or corrected, it was performed only in the microwave oven itself.

FIGS. 2a to 2d are views showing various screens displayed on the display unit when the recipe data stored in the conventional microwave oven is deleted.

When the user inputs a signal to confirm the contents stored in the recipe storage unit 8′ of the microwave oven, recipe menus stored currently in the recipe storage unit 8′ are displayed on the display unit 5′, as shown in FIG. 2a.

However, since the display unit 5′ provided on the microwave oven is small, it was difficult to display all the menus on a screen at one time in a case where a large amount of menus are stored. Therefore, according to the conventional microwave oven, the menus are divided into several groups each of which is fully displayed onto one screen so that the user can search and edit the desired menu from the screens.

When the desired menu is searched and selected, detailed information on the selected menu is displayed, as shown in FIG. 2b. At this time, if a cooking-start key or a recipe-delete key provided together is clicked, the microwave oven is correspondingly driven. That is, when the cooking-start key is selected, the cooking is started based on the recipe data the user has selected. Alternatively, when the recipe-delete key is selected, the recipe data the user has selected is deleted. As soon as the menu is deleted, a message is displayed on the screen to inform the user that the menu deletion has been properly performed, as shown in FIG. 2c.

Thereafter, when user's commands are inputted in order to confirm contents stored currently in the recipe storage unit 8′, the menus left currently in the recipe storage unit 8′ are displayed, as shown in FIG. 2d.

Consequently, a method of managing the recipe data for the conventional microwave oven has the following problems:

Only a limited amount of recipe data can be inputted in a memory device installed into the conventional microwave oven. Thus, in order to store a larger amount of recipe data, a storage capacity of the memory device should be increased. Since it causes an increase of the manufacturing cost, an expensive microwave oven is produced. Therefore, it is difficult to manufacture an inexpensive microwave oven.

Further, if the microwave oven manufactured as such is supplied to a consumer, only pre-programmed automatic cooking function stored in the memory device can be performed. As a result, there is a problem in that the cooking should be performed based on only the pre-programmed recipe data stored in the microwave oven.

Furthermore, the aforementioned operation for confirming and deleting the recipe data for the recipe menus stored in the microwave oven is performed on the small screen of the display unit provided on the microwave oven. However, since the display screen of the microwave oven is very small, it is difficult for the user to confirm the information on the recipe data within one page of the screen in the course of searching, confirming or deleting the recipe data for the recipe menus the user wants to store or select. Thus, there is inconvenience in that the information on the stored recipe data should be searched through troublesome procedures repeated over several times.

In addition, according to the conventional microwave oven, the information on the recipe data displayed on the display unit can be deleted one by one when the stored recipe data is to be deleted. That is, since a plurality of recipe data cannot be deleted at one time, there is a problem in that edition and management of the recipe data are troublesome.

### SUMMARY OF THE INVENTION

Therefore, an object of the present invention is to provide a device and method for storing and managing recipe data for a microwave oven, wherein the microwave oven is connected to a computer so that the microwave oven can perform data communication with the computer, and information on the recipe data can be downloaded from the web site to the microwave oven and stored in the microwave oven.

Another object of the present invention is to provide a device and method for storing and managing recipe data for a microwave oven, wherein information stored in the microwave oven can be edited through a large screen of a computer.

In order to accomplish these objects of the present invention, there is provided a device for storing and managing recipe data for a microwave oven which can perform data transmission to a computer connectable to a web site, comprising: a recipe storage means for receiving the recipe data for the microwave oven downloaded from the web site through the computer and storing the received recipe data; a first communication means through which the recipe data for the microwave oven can be transmitted to and received from the recipe storage means; and a microcomputer for controlling an operation by which the recipe data for the microwave oven received from the exterior through the first communication means can be stored in the recipe storage means.

The computer further comprises a second communication means for performing data communication with the first communication means of the microwave oven, a display means for receiving the recipe data stored in the microwave oven and displaying the received recipe data, and an editing means for editing the recipe data displayed on the display means and retransmitting information on the edited recipe data to the microwave oven.

The editing means of the computer comprises an input means for inputting a command of a user, and an interface module for controlling the computer so that the command from the input means can be performed.

In addition, there is provided a method of storing and managing recipe data for a microwave oven by using the microwave oven with a communication module and a computer capable of transmitting and receiving the data to and from the microwave oven through the communication module of the microwave oven, comprising the steps of:

downloading the recipe data for the microwave oven from a web site to the computer; transmitting the downloaded recipe data for the microwave oven to the microwave oven through the communication module of the microwave oven; and storing the recipe data for microwave oven transmitted to the microwave oven.

The method of storing and managing recipe data further comprises the steps of:

reading the recipe data for the microwave oven stored in the microwave oven onto the computer through the communication module and displaying the read recipe data on a display screen of the computer; editing the recipe data for the microwave oven displayed on the display screen of the computer; and retransmitting the edited recipe data for the microwave oven to the microwave oven.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram of a control section for a conventional microwave oven;

FIGS. 2a to 2d are views showing various screens displayed on a display unit when recipe data stored in the conventional microwave oven is deleted;

FIG. 3 is a conceptual view for explaining how the microwave oven according to the present invention stores the recipe data for the microwave oven from a web site;

FIG. 4 is a block diagram of control sections for managing the recipe data for the microwave oven stored in the microwave oven according to the present invention;

FIG. 5 is a structure of a signal packet to be downloaded to the microwave oven according to the present invention;

FIG. 6a is a view showing a screen output of a computer when the recipe data stored in the microwave oven according to the present invention will be deleted through the computer;

FIG. 6b is a view showing a screen output of the computer after the recipe data stored in the microwave oven according to the present invention has been deleted through the computer;

FIG. 7 is a view showing a screen output of the computer onto which recipe menu data from the web site are displayed for allowing the recipe menu data to be downloaded to a recipe storage unit of the microwave oven according to the present invention; and

FIG. 8 is a view showing a screen output of the computer on which both the recipe data stored in the recipe storage unit of the microwave oven according to the present invention and other downloadable recipe data contained within the web site are displayed.

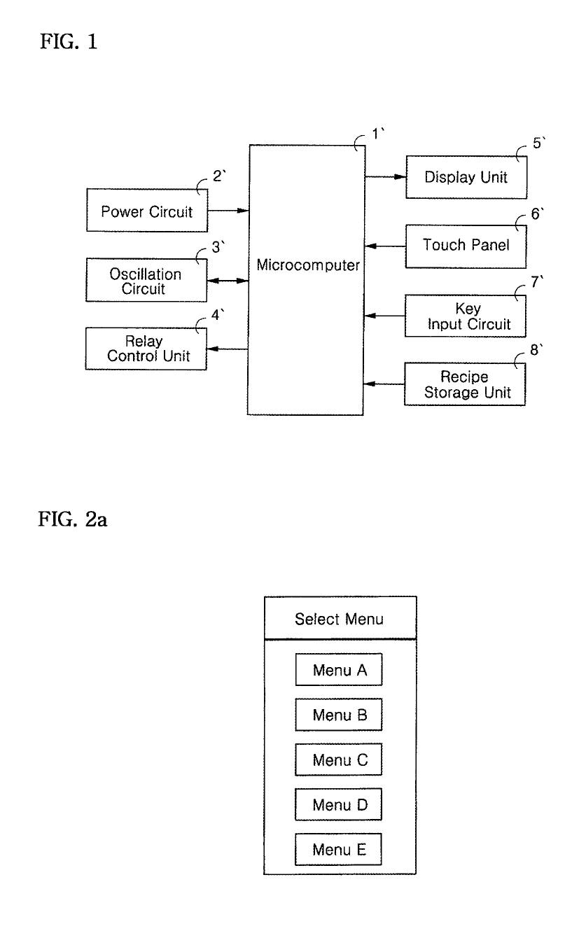

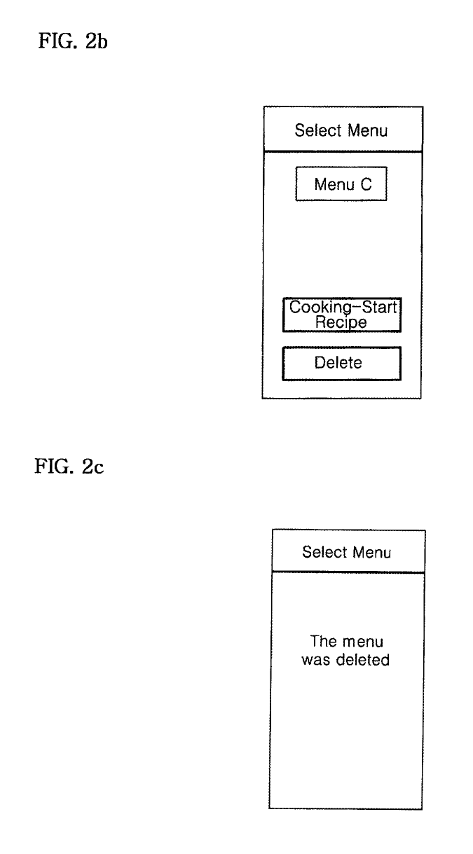

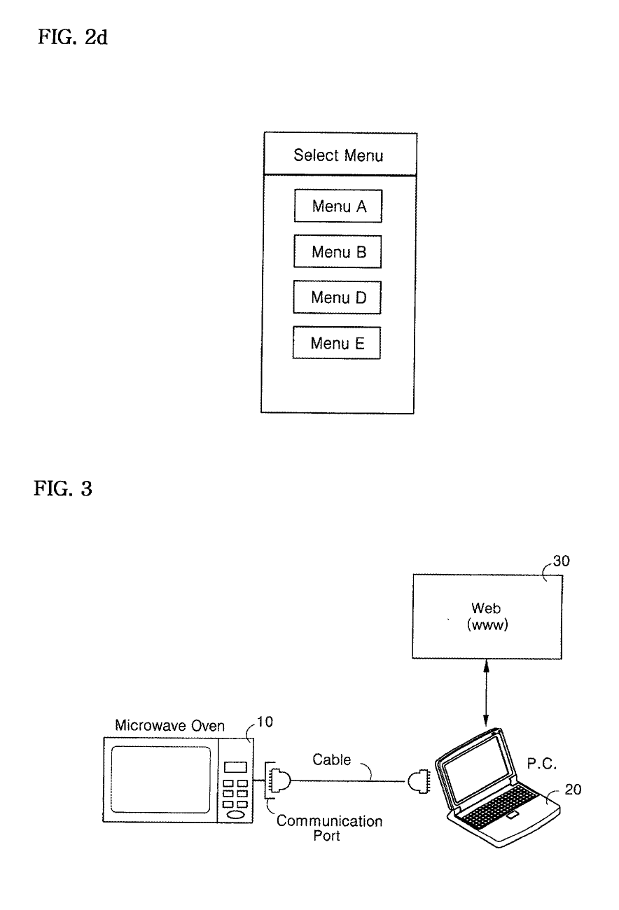

### DETAILED DESCRIPTION OF THE PREFERRED EMBODIMENTS

Hereinafter, a device and method for managing recipe data in a microwave oven according to the present invention will be described.

FIG. 3 is a conceptual view for explaining how the microwave oven according to the present invention stores the recipe data for the microwave oven from a web site.

In the figure, there are shown a web site 30 providing the recipe data for the microwave oven, a computer 20 which can be connected to the web site 30 and download, input and output information, and the microwave oven 10 connected to the computer 20 so that the downloaded recipe menu data can be stored therein and the stored data can be used.

The web site 30 includes various menu information for the microwave oven, which is divided into data to be displayed on a screen of the computer and data to be downloaded to the microwave oven 10.

The data to be displayed on the computer screen includes photographs, material, cuisine, and the like of relevant dishes. The data to be downloaded to the microwave oven 10 includes dish names, quantities, explanation texts and heating conditions for appropriate cooking, and the like of relevant menus.

With such constitutions, when the computer 20 is connected to the web site 30 and a communication module of the computer 20 and a communication module of the microwave oven 10 are connected to each other, the microwave oven 10 can receive information provided from the web site 30.

At this time, the microwave oven and the computer are connected through a communication cable to each other. The computer and the web site are connected through a high-speed information and communication network or the like to each other. The web site includes various menu information for the microwave oven, hardware control programs to be downloaded to the computer and the like.

That is, a user selects specific recipe data for the microwave oven which the user wants to download among the recipe data provided from the web site 30. Then, the recipe data for the microwave oven to be downloaded is first downloaded to the computer 20. Thereafter, the computer 20 transmits the downloaded recipe data for the microwave oven to the microwave oven. Thus, the recipe data for the microwave oven is stored in the microwave oven lo. Accordingly, with the recipe data stored in the microwave oven 10, newly changed recipes are provided to the user.

Hereinafter, operation control procedures for storing and managing the recipe data for the microwave oven stored as such using the computer connected to the microwave oven will be described in detail with reference to the accompanying drawings.

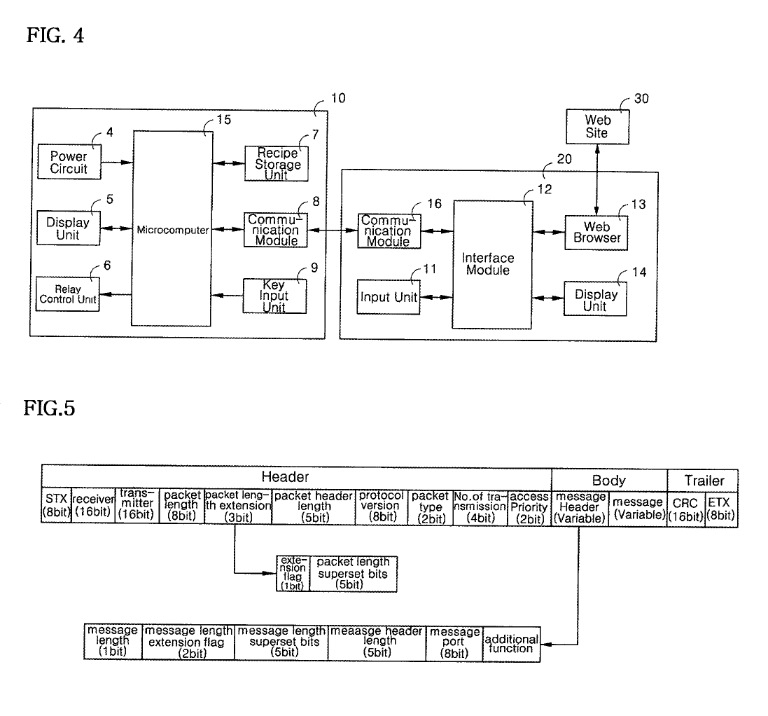

FIG. 4 is a block diagram of control sections for managing the recipe data for the microwave oven stored in the microwave oven according to the present invention.

A control section contained within the microwave oven 10 will be first described. As shown in the figure, the control section of the microwave oven 10 comprises a power circuit 4 for receiving power supplied from the exterior and supplying the received power to the microwave oven; a key input unit 9 for allowing the user to input signals for a desired recipe; a relay control unit 6 for driving and controlling a magnetron, a heater, a fan motor, an oven lamp, and the like to perform the recipe in response to the control signals inputted from the key input unit 9; a display unit 5 for displaying the recipe data selected by the user; a communication module 8 for transmitting and receiving signals so that the microwave oven 10 and the computer 20 are connected to each other; and a recipe storage unit 7 for storing the recipe data downloaded through the computer 20.

The control section further comprises a microcomputer 15 for performing a variety of recipe control and operations of the microwave oven 10 and editing the recipe data stored in the recipe storage unit 7 through communication with the computer 20.

The computer 20 comprises a web browser 13 for connecting the computer to the web site so that information provided from the web site 30 can be viewed; a display unit 14 for displaying the recipe data transmitted through the web browser 13 or the microwave oven 10; an interface module 12 for performing control such that the computer 20 can transmit and receive information from and to the web site 30 or the microwave oven 10 and input and output the information; an input unit 11 for allowing web site addresses to be inputted and menus to be selected on the web browser 13; and a communication module 16 for transmitting the recipe data downloaded from the web browser 13 to the microwave oven 10.

At this time, as for a specific embodiment of the recipe storage unit, the recipe storage unit contained within the microwave oven specifically comprises an EEPROM or a ROM. The EEPROM stores the downloaded recipe data. The ROM also stores data to be outputted onto the display unit.

If a ROM, a memory device, is further added to the control section, there can be expected the following effects: in a case where the microwave oven is equipped with a large display unit as the display unit, the signals of the recipe selected by the user can be stably outputted with a large volume of file such as a graphic file.

In the mean time, in a case where the microwave oven is not equipped with a separate large display unit, the recipe data stored in the recipe storage unit can be read, deleted and edited on the screen of the computer.

Automatic recipe information such as recipe names and recipe algorithms stored in the recipe storage unit can be deleted when the user makes an input through a specific key with his/her intention. The computer and the microwave oven are connected through the communication cable or the like to each other. At this time, signals required for the microwave oven are transmitted through a designated serial port.

A structure of the signal is shown in FIG. 5.

FIG. 5 is a structure of a signal packet to be downloaded to the microwave oven according to the present invention.

A protocol for the signal comprises a basic structure including a header, a body and a trailer. The header includes STX, a receiver's address (predetermined intrinsic code of the microwave oven), packet length, and the like. The body includes a message header, i.e. information on a message loaded in the packet (for example, information on message length, the existence of message extension, and the like), and a message.

The message is divided into predetermined commands and parameters accompanied by each command. In this command, key inputs for operations of reading a predetermined model name of the microwave oven, reading contents stored in the recipe storage unit, storing the contents in the recipe storage unit, deleting the contents stored in the recipe storage unit, and the like have respective unique codes; and key inputs for operations of inputting the addresses etc. are regarded as the accompanying parameters.

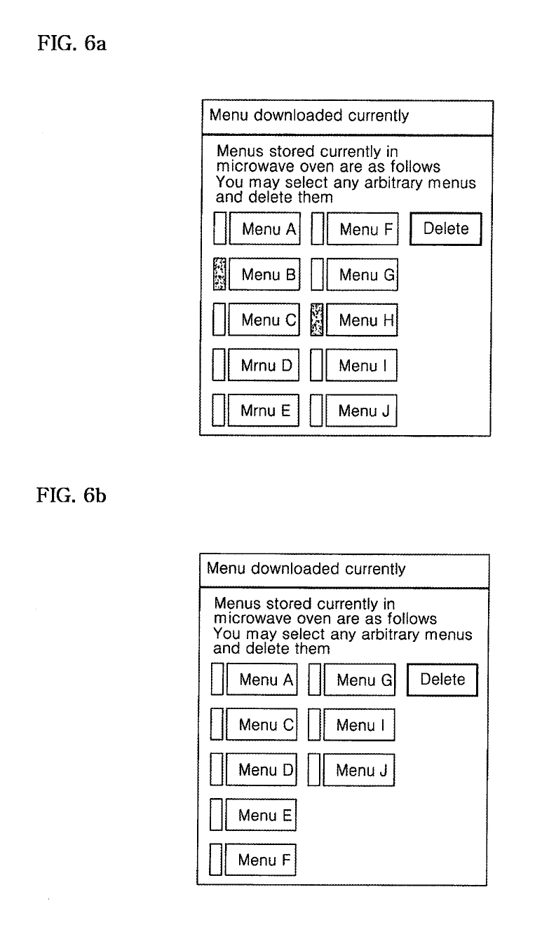

FIG. 6a is a view showing a screen output of a computer when the recipe data stored in the microwave oven 10 according to the present invention will be deleted through the computer 20; and FIG. 6b is a view showing a screen output of the computer 20 after the recipe data stored in the microwave oven 10 according to the present invention has been deleted through the computer 20.

The user inputs an edition command for the recipe menu data stored in the recipe storage unit 7 of the microwave oven 10 through an input unit 11 of the computer 20. Thus, the interface module 12 first requests the recipe data stored in the recipe storage unit 7 from the microwave oven 10.

The stored recipe menu data are inputted from the microwave oven 10 through the communication module 16 to the interface module 12 of the computer 20. Then, the interface module 12 transmits the read recipe data to the display unit 14 so that the user can edit the recipe data. The screen output displayed at this time is shown in FIG. 6a.

Next, the user selects one or more recipe menus to be edited through the input unit 11 while viewing the screen of the display unit 14 shown in FIG. 6a. When the selected menus are intended to be deleted, the user selects a “delete” button.

A signal generated by the edition performed in the computer 20 through these procedures is transmitted via the communication module 16 of the computer 20 to the communication module 8 of the microwave oven 10. The signal transmitted to the communication module 8 is transmitted to the microcomputer 15 in the microwave oven 10. The microcomputer 15 deletes the specific recipe menu stored in the recipe storage unit 7 in response to the deletion signal to be transmitted.

The microcomputer 15 transmits a signal showing that the contents of the recipe storage unit 7 have been modified from the communication module 8 of the microwave oven 10 to the communication module 16 of the computer 20. Thus, the computer 20 transmits the received signal through the interface module 12 to the display unit 14. The display unit 14, i.e. a monitor, displays the transmitted signal. That is, as shown in FIG. 6b, information on the recipe menus remaining in the recipe storage unit 7 excluding the deleted menu is outputted onto the display unit.

Thus, the microwave oven according to the present invention is constructed such that the user inputs an edition command for the recipe data stored in the recipe storage unit 7 of the microwave oven 10 through the input unit 11 of the computer 20. The edition command inputted through the computer 20 is transmitted, through the communication module 8 of the microwave oven 10 connected the communication module 16 of the computer 20, to the microwave oven 10. Thereafter, the edition command is performed under control of the microcomputer 15 contained within the microwave oven 10.

Next, a control operation of downloading the recipe data for the microwave oven provided from the web site 30 to the microwave oven 10 will be described.

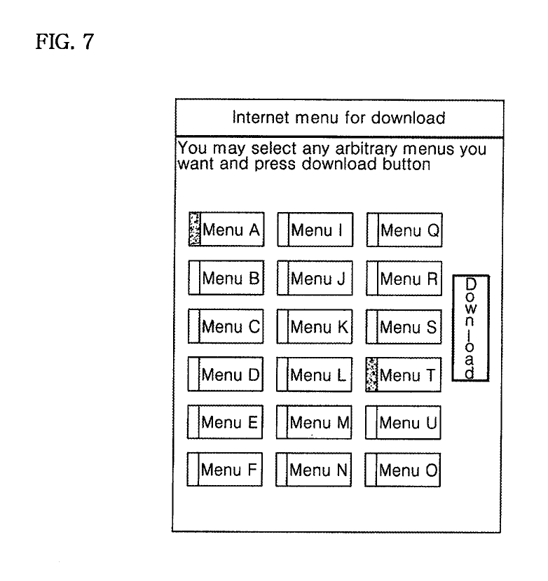

FIG. 7 is a view showing a screen output of the computer 20 onto which recipe menu data from the web site are displayed for allowing the recipe menu data to be downloaded to the recipe storage unit 7 of the microwave oven 10 according to the present invention.

When downloading the recipe menu data for the microwave oven from the web site 30 to the microwave oven 10, the user selects a desired recipe menu using the computer 20 under the conditions configured as shown in FIG. 7. Then, the recipe menus selected through the input unit 11 while viewing the screen output displayed on the display unit 14 of the computer 20 as shown in FIG. 7 is downloaded.

That is, the user selects one or more desired recipe menus and then selects a download button so as to command the download. The recipe data inputted through the web browser 13 to the computer 20 are transmitted through the communication module 16 to the microcomputer 15 of the microwave oven 10.

The microcomputer 15 provided with the recipe data downloaded through a path as described above recognizes the received data as the downloaded data, and controls the downloaded recipe data to be stored in the recipe storage unit 7. Thus, the recipe data downloaded from the web site 30 are stored in the recipe storage unit 7 using the computer 20.

At this time, the user confirms the recipe data downloadable through the web site 30 on the screen of the computer 20, as shown in FIG. 7. Thus, the user can check a download progressing status at a glance on the screen of the computer 20.

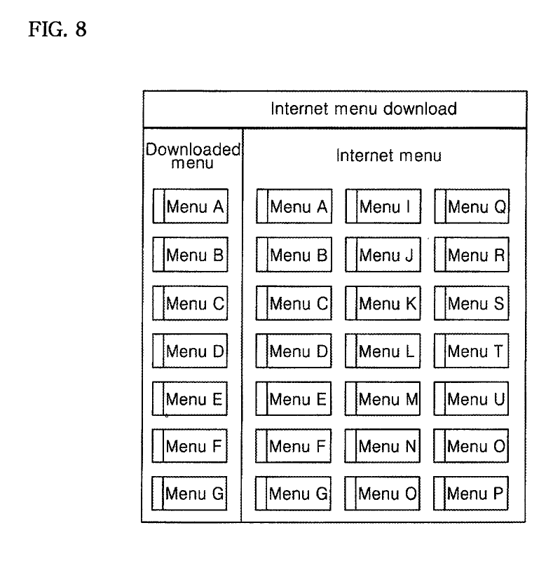

Next, FIG. 8 is a view showing a screen output of the computer 20 on which both the recipe data stored in the recipe storage unit 7 of the microwave oven 10 according to the present invention and other downloadable recipe data contained within the web site 30 are displayed.

That is, as can be seen from FIG. 8, in order to facilitate an edition operation for the contents stored in the recipe storage unit 7 of the microwave oven 10, the current recipe data stored in the microwave oven 10 and the other downloadable recipe data contained within the web site 30 can be displayed together on the screen of the computer 20. Thus, the user can grasp the deletion and download status at a glance.

As described above, it is a basic technical sprit of the present invention to connect the microwave oven to the computer, to store the recipe data in the microwave oven, and to allow the stored recipe data to be confirmed and edited on the screen of the computer.

At this time, the recipe data stored in the microwave oven and the recipe data downloadable from the web site can be displayed together. Thus, the recipe data stored in the recipe storage unit of the microwave oven can be grasped at a glance, and at the same time, other downloadable recipe data can be confirmed.

Therefore, according to the present invention, there can be expected the following effects:

The user can receive desired recipe data from the web site without limit, if necessary. Operations for confirming and deleting the recipe menus stored in the microwave oven can be performed through the display unit, i.e. a monitor, of the computer connected to the microwave oven. At this time, the confirmation operation of a conventional microwave oven is performed on a small screen thereof, whereas the confirmation operation in the present invention can be grasped at a glance through the monitor of the computer.

Furthermore, when the recipe data stored in the microwave oven are intended to be deleted, the user can select one or more recipe data outputted on the monitor and delete them at one time. As a result, the recipe data can be effectively managed in a short time.

Therefore, the user can get maximum satisfaction from the microwave oven according to the present invention.

The present invention is not limited to the embodiment as described above, but defined by the claims. It can be understood by the skilled in the art that various changes and modifications can be made thereto within the scope and spirit of the invention defined by the claims.

What is claimed is:

1. A device for storing and managing recipe data for a microwave oven which can perform data transmission to a computer connectable to a web site, comprising:
a recipe storage means for receiving the recipe data for the microwave oven downloaded from the web site through the computer and storing the received recipe data;
a first communication means through which the recipe data for the microwave oven can be transmitted to and received from the recipe storage means; and
a microcomputer for controlling an operation by which the recipe data for the microwave oven received from the exterior through the first communication means can be stored in the recipe storage means.

2. The device as claimed in claim 1, wherein the computer further comprises a second communication means for performing data communication with the first communication means of the microwave oven, a display means for receiving the recipe data stored in the microwave oven and displaying the received recipe data, and an editing means for editing the recipe data displayed on the display means and retransmitting information on the edited recipe data to the microwave oven.

3. The device as claimed in claim 2, wherein the editing means of the computer comprises an input means for inputting a command of a user, and an interface module for controlling the computer so that the command from the input means can be performed.

4. The device as claimed in claim 1, wherein the computer connectable to the web site downloads from the web site a hardware driver for transmitting a predetermined signal according to a predetermined protocol to the microwave oven, and the hardware driver allows a clock signal according to the predetermined protocol to be transferred through a serial port.

5. The device as claimed in claim 4, wherein the hardware driver has a function of a web browser connectable to a specific web site, allows the computer to be connected directly to the specific web site from which the recipe data for automatic cooking can be downloaded upon its execution in the computer in a case where the computer is connected to the microwave oven through the serial port, and converts a signal packet including commands, accompanying parameters and headers corresponding to information on the commands and parameters into a clock signal according to the predetermined protocol; and the downloaded recipe data for automatic cooking is included in the accompanying parameters.

6. A method of storing and managing recipe data for a microwave oven by using the microwave oven with a communication module and a computer capable of transmitting and receiving the data to and from the microwave oven through the communication module of the microwave oven, comprising the steps of:
downloading the recipe data for the microwave oven from a web site to the computer;
transmitting the downloaded recipe data for the microwave oven to the microwave oven through the communication module of the microwave oven; and
storing the recipe data for microwave oven transmitted to the microwave oven.

7. The method as claimed in claim 6, further comprising the steps of:
reading the recipe data for the microwave oven stored in the microwave oven onto the computer through the communication module and displaying the read recipe data on a display screen of the computer; editing the recipe data for the microwave oven displayed on the display screen of the computer; and retransmitting the edited recipe data for the microwave oven to the microwave oven.
